(19) United States
(12) Patent Application Publication
(10) Pub. No.: US 2014/0004491 A1
(43) Pub. Date: Jan. 2, 2014

(54) METHOD AND SYSTEM FOR COGNITIVE AND SOCIAL FUNCTIONING ENHANCEMENT

(71) Applicant: Nicole SCHEIDL, Orleans (CA)

(72) Inventor: Nicole SCHEIDL, Orleans (CA)

(21) Appl. No.: 13/930,857

(22) Filed: Jun. 28, 2013

Related U.S. Application Data
(60) Provisional application No. 61/665,680, filed on Jun. 28, 2012.

(30) Foreign Application Priority Data
Jun. 28, 2012 (CA) 2781253

(51) Int. Cl. G09B 19/00

(52) U.S. Cl. CPC G09B 19/00
USPC 434/236

(57) ABSTRACT

The present invention provides a system for maintaining brain activity and for providing stimulation for compromised functions for at least one individual having at least one cognitive impairment, the system comprising a plurality of games having: at least one game relating to words, at least one game relating to visual and spatial and orientation, at least one game relating to numbers, and at least one game relating to shapes and colours. The present invention further provides instructions to play the games and means for assessing the results of the games played according to pre-determined criteria.

### FIELD OF THE INVENTION

The present invention relates to an interactive behavioural training system for enhancing an individual's cognitive and social functioning.

### BACKGROUND

While science has not found a cure for cognitive impairments like Alzheimer's and dementia, there is evidence that the brain is capable of making new connections to replace ones that have been lost at the early stages of these types of impairments. This ability of the brain is called neuroplasticity. Recent findings suggest that cognitive training can help create and sustain these new connections.

After an individual has been diagnosed with a cognitive impairment, there is a tendency of patients and caregivers to focus attention solely on the functions that have been lost. This leaves the intact cognitive functions unrecognized and unreinforced. While the gradual decline of cognitive functioning cannot be stopped entirely, some cognitive training and stimulation may play a significant role in slowing down the physiological progress of these diseases. Such training may maximize an individual's ability to function for an extended period of time.

Furthermore, various studies show that the meaningful interactions between patients and their loved ones can strengthen inter-relational social connections. Therefore, a training system designed to stimulate compromised cognitive functions and the active parts of the brain may have several physiologically and socially therapeutic benefits.

While there are many pharmacological intervention techniques that can be used to promote an individual's cognitive capacities, the use of these often are accompanied with adverse side effects.

One approach involves the use of an acetyl choline esterase inhibitor (AChEI) to treat Alzheimer-type dementia (disclosed in Canadian Patent Number 2,773,592, by Chase et al.). Using AChEI in combination with an enhanced acetyl choline esterase inhibition can alleviate the symptoms of Alzheimer-type dementia in the patient. The side-effects of these pharmacological compounds, however, are not entirely controllable and can exacerbate an individual's attention difficulties. They can produce side effects such as nervousness, restlessness, difficulty falling asleep or staying asleep, and uncontrollable shaking of a part of the body. By avoiding the use of pharmacological compounds, these side effects can be avoided.

U.S. Pat. No. 7,711,578, by Williams et al., teaches the use of crossword games in conjunction with methods and systems for promoting and managing communications among a social support network. It teaches the use of crosswords by “members of a home care agency, a geriatric consultant, or members of a specialized support group (e.g., for Alzheimer's care).” However, it fails to teach the use of crossword games in a manner that would not only promote social communications, but also in a manner that enhances the cognitive abilities of the individuals completing the crossword games.

Another prior art patent, U.S. Pat. No. 6,162,059, by Murphy et al., teaches a problem solving skills development system using tactile recognition wherein a user is to match similar shapes together in order to develop visually impaired individuals' problem solving skills. It does not, however, teach a method and system of shape matching for the purpose of promoting the cognitive abilities of a person suffering from a cognitive impairment, such as but not limited to dementia, Alzheimer's or a learning disability.

The present invention seeks to overcome the drawbacks and shortcomings of the prior art.

### SUMMARY OF THE INVENTION

The present invention seeks to provide systems and methods for actively maintaining the healthy parts of the brain and for providing stimulation for compromised functions in a comprehensive and holistic way. The present invention also seeks to create and sustain socially meaningful interactions that will enable cognitively impaired individuals to socially engage with their peers, loved ones and caregivers. The present invention and its various embodiments provide caregivers (professional or otherwise, such as family or friends) with a structured and user-friendly system and method that will help support the cognitively impaired individual's remaining cognitive capacities and the individual's ability to communicate with other people.

Specifically, the system of the present invention includes interactive game sets with pieces designed for caregivers to use with at least one individual having cognitive impairment.

The systems and methods of the present invention may be useful for, but not limited to, individuals with attention deficit hyperactivity disorder, age-relate cognitive decline, Down's syndrome, dementia, Alzheimer's disease, and other neurodegenerative diseases, and those who are cognitively impaired because of a stroke.

In a first aspect, the present invention provides a system for maintaining brain activity and for providing stimulation for compromised functions for at least one individual having cognitive impairment, the system comprising a plurality of games having: at least one word related game; at least one visual and spatial orientation related game; at least one number related game; and at least one game relating to shapes and colours.

In a second aspect, the present invention provides a method for maintaining brain activity and for providing stimulation for compromised functions for at least one individual having cognitive impairment, the method comprising steps: (a) providing at least one word related game; (b) providing at least one visual and spatial orientation related game; (c) providing at least one number related game; (d) providing at least one game relating to shapes and colours; (e) providing instructions to play the games provided in steps (a) through (d); and (f) assessing the results of the games played provided in steps (a) through (d) according to pre-determined criteria.

### BRIEF DESCRIPTION OF THE DRAWINGS

The embodiments of the present invention will now be described by reference to the following figures, in which identical reference numerals in different figures indicate identical elements and in which:

FIG. 1 illustrates a tic-tac-toe-type board with game pieces having one side laminated with geometrical shapes according to one embodiment of the present invention;

FIG. 2 illustrates a pattern completion game according to another embodiment of the present invention;

FIG. 3 illustrates a Sudoku-type board with game pieces having one side laminated with numerals according to a further embodiment of the present invention;

FIG. 4 is a flowchart of a method for creating a themed crossword game according to another embodiment of the present invention;

FIG. 5 is a flowchart of a method for creating a themed word search game according to a further embodiment of the present invention.

FIG. 6 illustrates an activities of daily living game board according to another embodiment of the present invention; and

FIG. 7 illustrates game pieces having one side laminated with a graphic, according to a further embodiment of the present invention.

The Figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention.

### DETAILED DESCRIPTION

The present invention provides systems and methods comprising games to be used by family, friends, or caregivers (professional or otherwise) with at least one individual having at least one cognitive impairment.

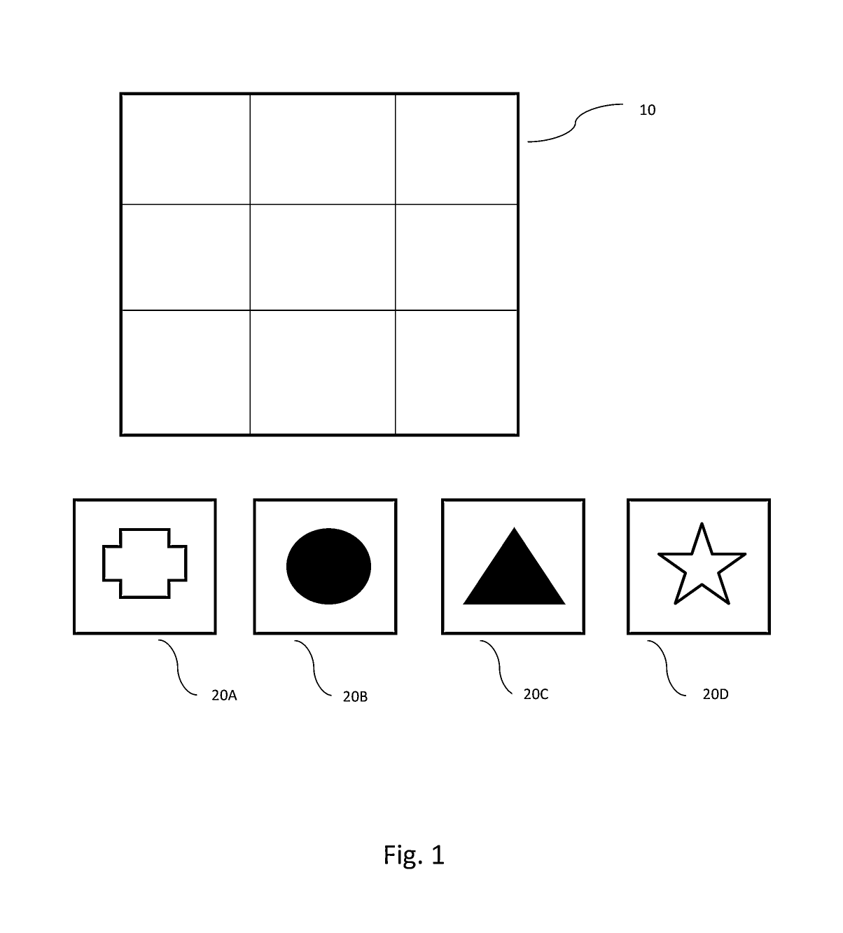

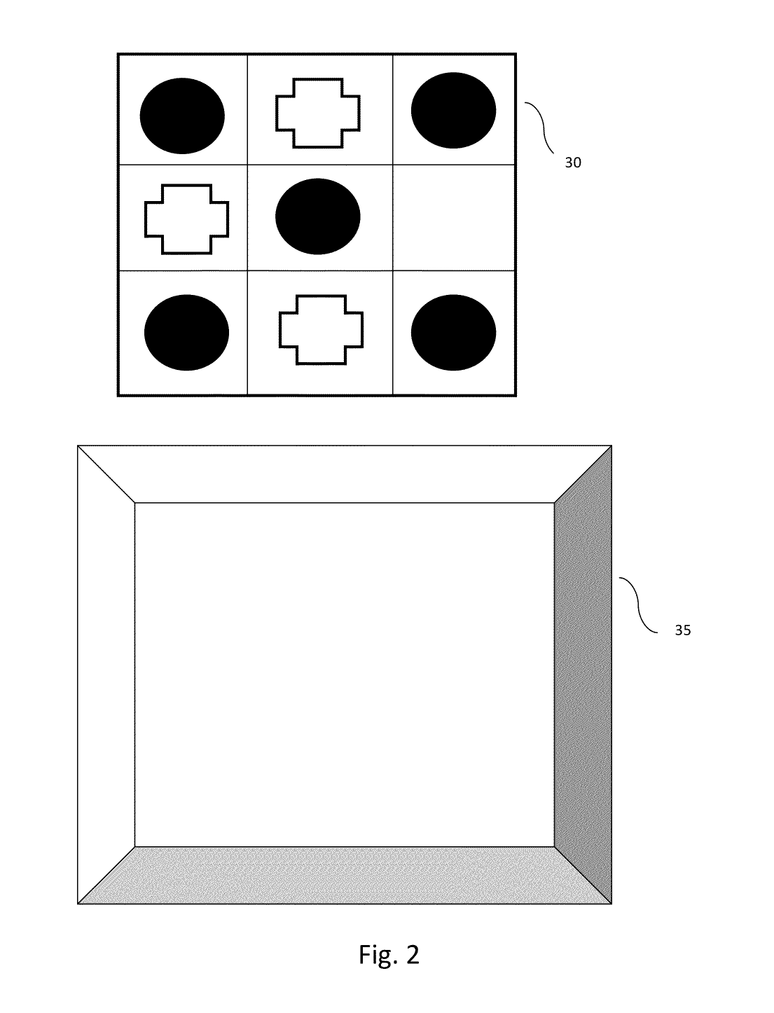

According to one embodiment of the present invention, the system and method includes at least one game having a tic-tac-toe-type board. FIG. 1 shows an exemplary board 10, with delineated empty spaces, and game pieces 20A, 20B, 20C, and 20D being made of a magnetic rubber. The board 10 and the game pieces 20A, 20B, 20C, and 20D are operatively coupled to a metal board 35 (shown in FIG. 2), such that the magnetic forces maintain the magnetic game pieces 20A, 20B, 20C, and 20D on the board 10 when placed in their respective space. Each magnetic rubber piece is laminated on one side with a geometrical shape. The shapes may include, but are not limited to, a cross, a circle, a triangle, and a star. Other shapes may be used in place of, or in addition to, the above listed shapes.

While the game pieces 20A, 20B, 20C, and 20D are shown in FIG. 1 as being square-shaped, a rectangular or more circular shape may be contemplated. Other shapes are also contemplated. The object of the game is to align the same colour and shape piece in a horizontal, vertical or diagonal row.

Furthermore, while the use of magnetic rubber material is considered a preferred embodiment of the present invention, it is not a required element of the game.

The magnetic tic-tac-toe-type game includes an instruction set (not shown) that is utilized by a caregiver, or the like, to play tic-tac-toe with at least one cognitively impaired individual. By using different geometrical shapes, the individual trains and improves their cognitive ability to sort, sequence, and solves problems involving the recognition of patterns. Additionally, the magnetic tic-tac-toe game provides a medium through which a caregiver can socially engage the individual. Therefore, the magnetic tic-tac-toe game provides a method of improving the spatial recognition cognitive abilities of the individual and a method of socially engaging the individual, thereby providing therapeutic social interaction.

FIG. 2 shows an exemplary pattern matching board 30 for a pattern matching game. This particular game is used with game pieces similar to the pieces laminated with geometrical shapes 20A, 20B, 20C, 20D in FIG. 1. In a preferred embodiment, the game pieces are made of magnetic rubber and have other geometrical shapes for pattern matching by a cognitively impaired individual under the supervision of a caregiver. The pattern matching game board 30 contains at least one blank space upon which a game piece is placed to complete a specific pattern. The present invention contemplates altering the particular pattern matching game illustrated in FIG. 2 to include more blank spaces and alternative geometrical shapes.

According to the pattern matching game illustrated in FIG. 2, an individual completes the pattern using the available geometrical shapes. By examining and recognizing at least one pattern in the pattern matching game, the individual improves their cognitive ability to understand three-dimensional shapes and the relationships between them. Additionally, the pattern matching game provides a medium through which a caregiver, or otherwise, can socially engage the individual. Therefore, the pattern matching game of the present invention provides a method of improving the spatial recognition cognitive abilities of the individual and a method of socially engaging the individual, thereby providing therapeutic social interaction.

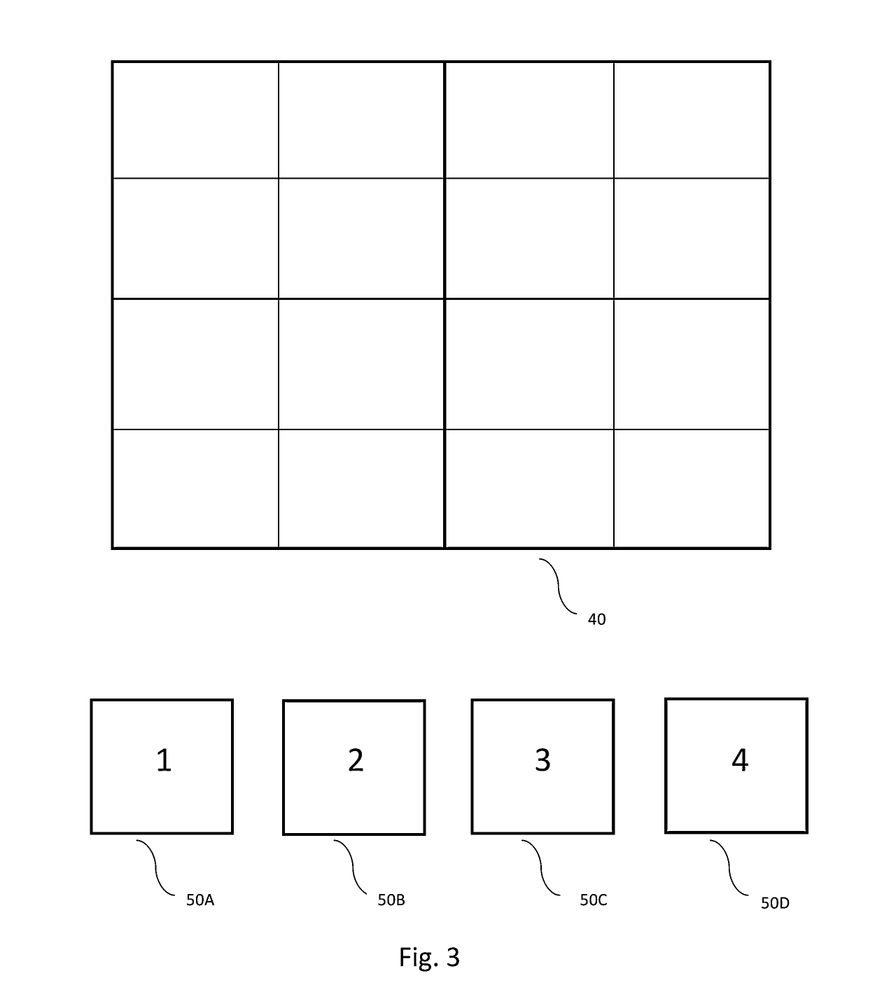

FIG. 3 shows a Sudoku-type game in accordance with another embodiment of the present invention. The Sudoku-type game includes a Sudoku-type board 40 and game pieces 50A, 50B, 50C, 50D. According to a preferred embodiment, the blank Sudoku board 40 is separated into four sections consisting of four squares in the top left quadrant, four squares in the top right quadrant, four squares in the bottom left quadrant, and four squares in the bottom right quadrant. Each quadrant is coloured to provide cuing, but other visual cuing such as shading or lines are also envisaged. The board 40 can be prefilled with at least one number in any of the squares. The game pieces 50A, 50B, 50C, 50D include a number on one side that may be laminated thereon. The game pieces 50A, 50B, 50C, 50D may be made from a magnetic rubber material. These game pieces 50A, 50B, 50C, 50D pieces are used to complete the Sudoku-type game. The game pieces are also coloured to match the quadrants and provide cuing, but other visual cuing such as shading or lines are also envisaged.

The Sudoku-type game is completed by placing the magnetic pieces 50A, 50B, 50C, 50D so that each of the numbers 1 through 4 appear only once in each row and column, and appear only once in each of the top left, top right, bottom left, and bottom right quadrants.

The present invention is not limited to a 4×4 sized board and is not limited to the numbers 1 through 4 appearing on the magnetic pieces, but could include larger sized boards that could be used if the cognitive capacities of the individual with a cognitive impairment warranted an increase in the difficulty of the game.

The Sudoku-type game allows an individual with a cognitive impairment to maintain and improve their critical thinking capacities by allowing them to engage in an activity that uses logic and numbers. In addition, it provides a method of engaging the individual socially by allowing a caregiver to aid and supervise the completion of the Sudoku-type game. As such, the Sudoku-type game provides a method of improving the critical thinking cognitive abilities of the individual and a method of socially engaging the individual, thereby providing therapeutic social interaction.

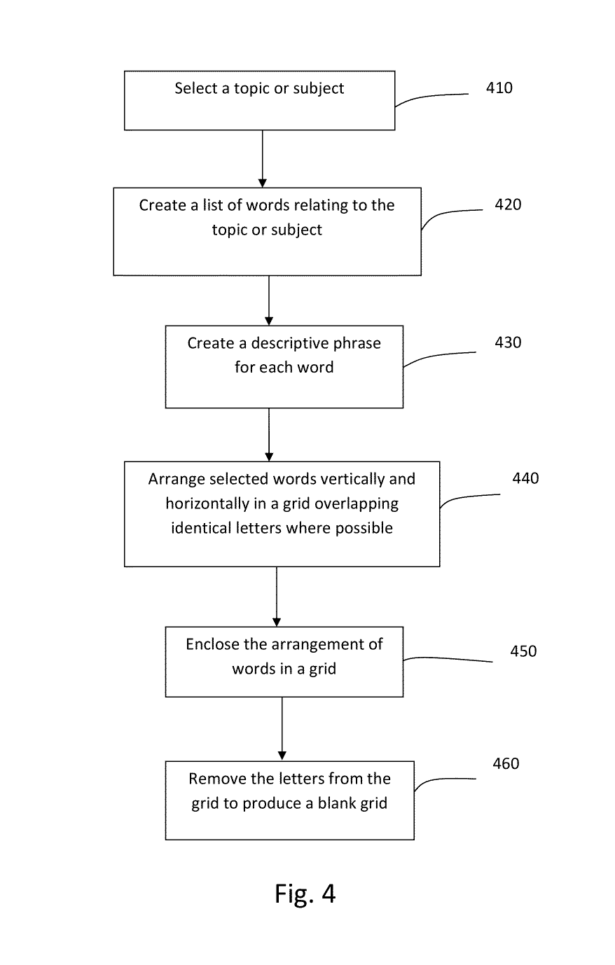

FIG. 4 shows a method of creating themed crossword games. This method begins with step 410 of selecting a topic or subject area. Next step, the method follows step 420 in creating a list of words that relate to the selected topic. These words become the answers to the themed crossword game. Following that, step 430 involves creating a descriptive phrase for each word that acts as a clue that can be used by the person completing the game to rationally arrive at the answer word. Next, step 440 involves arranging some of the words horizontally and some of the words vertically with identical letters from different words overlapping where possible. A further step 450 involves enclosing each the arrangement of words in a grid with empty space being darkened. Finally, step 460 involves erasing the answer letters from the grid to produce a blank grid of some empty and some darkened spaces.

A themed crossword game may be used to maintain and improve the current language capacities of a cognitively impaired individual. The game can be completed with a caregiver, a friend, or family, and enables them to also socially engage a cognitively impaired individual.

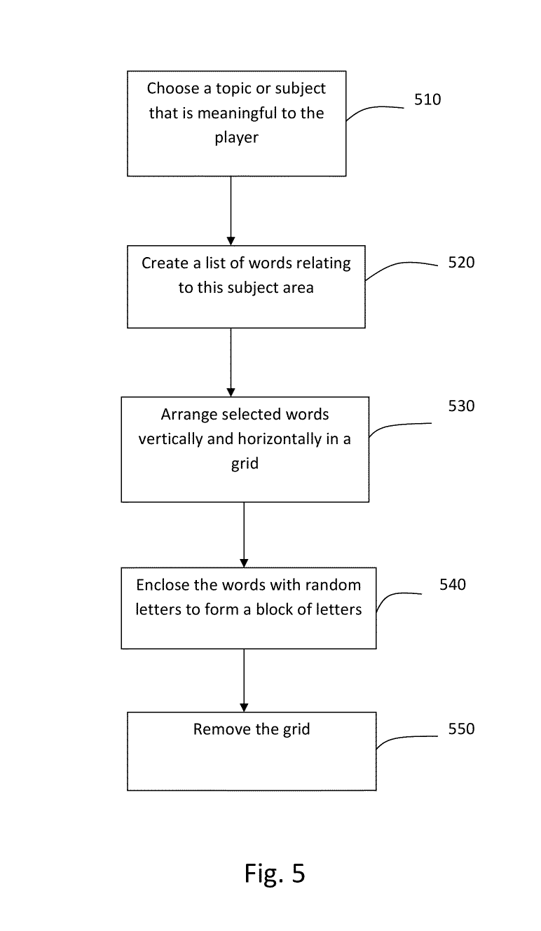

FIG. 5 shows a method of creating a themed word search game. The method begins at step 510 by choosing a topic or subject area. Next, step 520 involves creating answer words that consist of a list of words relating to this topic. Following that, step 530 involves creating a grid and then arranging the answer words vertically and horizontally within the grid, overlapping identical letters where possible. Next, step 540 involves inserting random letters in any blank spaces within the grid. Finally, step 550 involves removing the grid lines to leave a block of letters.

To complete the themed word search game, a list of answer words is used to find the answer words in the grid of letters. The player finds and marks all the answer words within the grid. This game is advantageous for maintaining the language capacities and improving the spatial and pattern recognition abilities of a cognitively impaired individual.

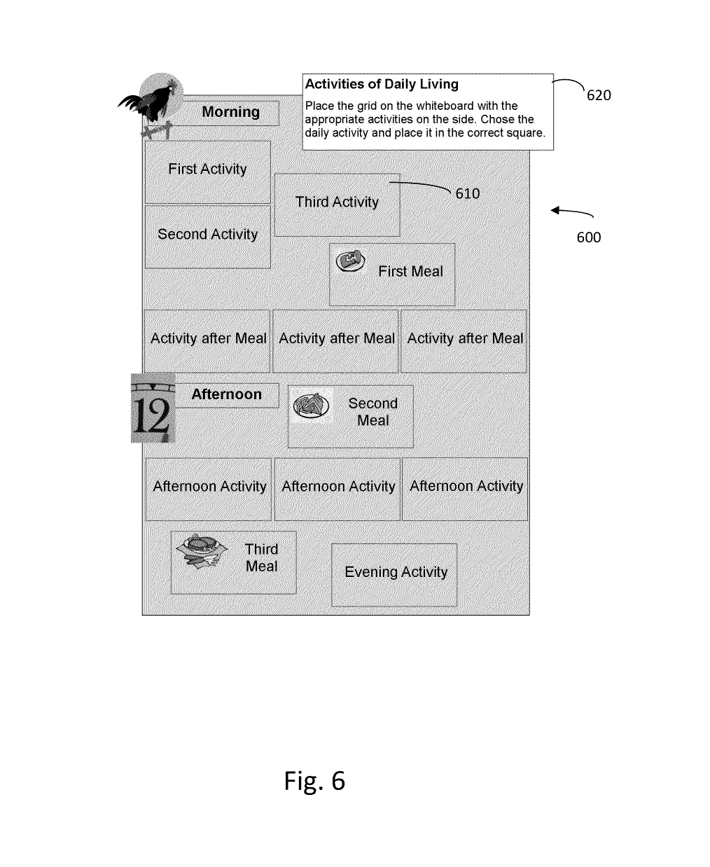

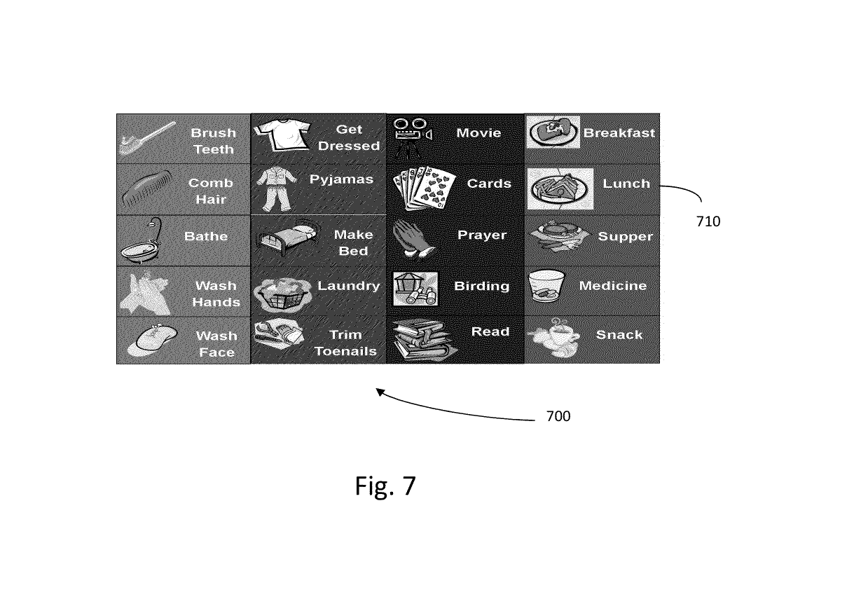

FIG. 6 shows an exemplary activities of daily living board 600 for an activities of daily living game. The board 600 contains a plurality of grid spaces 610, each having a word indicating a numbered activity or a specific activity that a person encounters in their daily life. Here, the grid spaces are shown as rectangular, but they may be any enclosed shape, such as but not limited to squares, circles, etc. The board also contains an instruction set 620 indicating how the game is meant to be played. An individual completes the game using game pieces 700 (shown in FIG. 7).

This particular game board 600 shows the plurality of grid spaces temporally organized, such that the grid spaces containing activities associated with morning activities appear above grid spaces containing activities associated with afternoon activities. The present invention also contemplates other temporally organized activities, such as but not limited to days and evenings, weekdays, or weekends, for example.

FIG. 7 shows a set of exemplary game pieces 700. In a preferred embodiment, the game pieces 700 are made of magnetic rubber and have graphics laminated on one side. Each game piece graphic 710 has a word (or words) and an associative image relating to that word. Each game piece graphic 710 also relates to at least one of the words contained in the plurality of grid spaces 610 (shown in FIG. 6). This game is played by matching each game piece 700 with the proper corresponding rectangle 610 (shown in FIG. 6). The game pieces 700 are to be used by a cognitively impaired individual under the supervision of a caregiver. By associating the correct game piece 710 with the correct grid space 610 (shown in FIG. 6), the individual improves their ability to understand aspects of spatial and visual orientation. This game is therefore advantageous for maintaining and improving the spatial and visual orientation capacities of a cognitively impaired individual.

The present invention contemplates altering the particular activities of daily living game illustrated in FIG. 6 and FIG. 7 to include alternative and additional graphics, shapes, and words.

While the present invention is implemented using non-electronic means and materials, the present invention contemplates embodying the systems and methods in electronic computing devices, including but not limited to, tablet computing devices, smart phones, handheld electronic devices, etc.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g.“C”) or an object oriented language (e.g.“C++”). Alternative embodiments of the invention may be implemented as pre-programmed hardware elements, other related components, or as a combination of hardware and software components. Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

What is claimed is:

1. A system for maintaining brain activity and for providing stimulation for compromised functions for at least one individual having cognitive impairment, the system comprising a plurality of games having:
at least one game relating to words;
at least one game relating to visual and spatial orientation;
at least one game relating to numbers; and
at least one game relating to shapes and colours.

2. The system as in claim 1, wherein the at least one game relating to shapes and colours includes a tic-tac-toe-type game having:
a metallic board;
a frame separated into nine spaces by two horizontal lines and two vertical lines;
at least nine game pieces, being made from a magnetic material, each having a graphic on one side, such that each graphic has at least two geometrical shapes and each shape has a distinctive colour, and the at least nine game pieces for operatively coupling the frame to the metallic board by magnetic force; and
wherein the at least nine game pieces having the same graphic are aligned in a row of spaces within the frame.

3. The system as in claim 1, wherein the at least one game relating to shapes and colours includes a pattern completion game having:
a metallic board;
a frame separated into nine spaces by two horizontal lines and two vertical lines;
at least nine game pieces, being made from a magnetic material, each having a graphic on one side, such that each graphic has at least two geometrical shapes and each shape has a distinctive colour, and at least one of the at least nine game pieces for operatively coupling the frame to the metallic board by magnetic force;
wherein at least two of the nine spaces of the frame each have a corresponding graphic thereon to form empty spaces within the nine spaces; and
wherein at least one of the least nine game pieces are positioned within the empty spaces to complete a pattern of graphics.

5. The system as in claim 1, wherein the at least one game relating to numbers includes a magnetic Sudoku-type game having:
a metallic board;
a frame separated into at least sixteen spaces by at least three vertical lines and at least three horizontal lines to form four sections consisting of a top left quadrant of four squares, a top right quadrant of four squares, a bottom left quadrant of four squares, and a bottom right quadrant of four squares; and
at least sixteen game pieces, being made from a magnetic material, each having a graphic on one side, such that the graphic is a numeral of one through four, and at least one of the at least sixteen game pieces for operatively coupling to the metallic board through magnetic means; and
wherein each of the four numbers appears only once in each row and column of the frame, and appear only once in each of the top left quadrant, the top right quadrant, the bottom left quadrant, and the bottom right four square sections.

6. The system as in claim 1, wherein the at least one game relating to words includes a themed crossword game having:
answer words that are words relating to a single subject area;
a descriptive phrase for each of the answer words; and
a grid of lines that defines spaces arranged in parallel rows and columns; and
wherein the answer words are arranged in any direction in a row in the grid to overlap where possible and wherein darkened spaces fill the empty spaces between the answer words; and
wherein a blank grid is produced by removing the answer words from the grid to leave blank spaces and the darkened spaces.

7. The system as in claim 1, wherein the at least one game relating to words includes a themed word search game having:
answers that are words from related subject matter; and
a grid of lines that defines spaces arranged in parallel rows and columns;
wherein the answer words are arranged in any direction in a row in the grid to overlap where possible; and
wherein the arranged words are surrounded by random letters to form a grid of letters, without defined lines, arranged in rows and columns.

8. The system as in claim 1, wherein the at least one game relating to visual and spatial orientation includes an activities of daily living game comprising:
a metallic board;
a frame separated into a plurality of grid spaces, such that each of the grid spaces contains at least one word associated with at least one activity of daily living;
at least one game piece, being made from a magnetic material, each having a graphic on one side, such that each graphic has at least one word and an associative image related to the at least one word, and the at least one game pieces for operatively coupling the frame to the metallic board by magnetic force; and
wherein the at least one game piece is positioned within the plurality of grid spaces containing the at least one word associated with the activity of daily living that corresponds to the at least one game piece graphic.

9. The system as in claim 7, wherein the frame has a plurality of grid spaces that are temporally organized, such that each grid spaces containing at least one word associated with a morning activity of daily living appears in sequence before another grid space containing at least one word associated with an afternoon activity of daily living.

10. A method for maintaining brain activity and for providing stimulation for compromised functions for at least one individual having cognitive impairment, the method comprising steps:
(a) providing at least one game relating to words;
(b) providing at least one game relating to visual and spatial orientation;
(c) providing at least one game relating to numbers, and
(d) providing at least one game relating to shapes and colours;
(e) providing instructions to play the games provided in steps (a) through (d); and
(f) assessing the results of the games played provided in steps (a) through (d) according to pre-determined criteria.
